(19) United States
(12) Patent Application Publication
(10) Pub. No.: US 2010/0270719 A1
(43) Pub. Date: Oct. 28, 2010

(54) RUBBER SPRING FOR A VEHICLE WHEEL AXLE SUSPENSION

(75) Inventors: Odd Ranum, Dals Rostock (SE); Lars Hedlund, Goteborg (SE)

Correspondence Address: WRB-IP LLP, 801 N. Pitt Street, Suite 123, ALEXANDRIA, VA, 22314, US

(73) Assignee: VOLVO LASTVAGNAR AB, Goteborg (SE)

(21) Appl. No.: 11/993,034

(22) PCT Filed: Jun. 28, 2006
(86) PCT No.: PCT/SE06/00796

§ 371 Date: Dec. 19, 2007

(30) Foreign Application Priority Data
Jun. 30, 2005 (SE) 0501533-4

(51) Int. Cl. B60G 11/40; F16F 1/40

(52) U.S. Cl. 267/294; 267/292

(57) ABSTRACT

A rubber spring (7) for a vehicle axle leaf spring suspension comprises a rubber pillar (8) which at an upper end is attached to a tunnel shaped mounting member (20) having a tunnel (13) with interior upper and lower surfaces (21,22) and adapted to house an end portion of a spring leaf (6) of a leaf spring suspension. The upper and lower surfaces are convex so as to allow tilting of the rubber pillow relative to the spring leaf.

The present invention relates to a rubber spring for a vehicle wheel leaf spring suspension, said rubber spring comprising a rubber pillar attached at one end to a mounting plate adapted to be fixed to a wheel axle casing and at the opposite end to a tunnel shaped mounting member for housing an end of a spring leaf of a leaf spring suspension, said tunnel shaped mounting member having opposite interior surfaces adapted to face opposite surfaces of a spring leaf.

Previously known rubber springs designed as described above have tunnel shaped mounting members wherein the tunnel has opposite interior surfaces which are plane and parallel with one another, thereby allowing sliding but no or at the most very limited tilting movement of the rubber spring relative to the spring leaf of a leaf spring wheel suspension. This makes the mounting process rather complicated, when a wheel axle casing for a heavy truck is to be fixed to a rubber spring already mounted on the spring leaf, because all relative movement between the mounting plate and the axle casing, when aligning the mounting plate fasteners with corresponding fastening means on the axle casing, has to be concentrated to movement of the casing. Such a wheel axle casing with related components can weigh up to 1.5 ton. Therefore, all relative movement between the mounting plate on the rubber spring and the axle casing require the use of power operated jacking equipment.

The purpose of the present invention is to obtain a rubber spring as described by way of introduction which makes the mounting process when attaching the rubber spring to the axle casing less complicated and time consuming and therefore also less costly.

This is obtained by virtue of the fact that said opposite interior surfaces of the mounting member are shaped so as to allow tilting of the pillar relative to a first spring leaf housed in the tunnel.

In a preferred embodiment of the rubber spring according to the present invention said opposite interior surfaces of the mounting member are convex.

In a further development of the rubber spring according to the present invention, adapted for leaf spring suspensions having a plurality of leaf spring elements stacked on top of one another, said mounting member has an upper exterior surface shaped so as to allow tilting of the pillar relative to a second spring leaf located above the first spring leaf.

Since the mounting member can slide as well as tilt relative to the spring leaf end portion all relative movements between the rubber spring and the wheel axle can be performed by manual movement of the rubber spring, thereby eliminating the need for power operated jacking equipment during the final alignment of the components.

The invention will be described in more detail with reference to the accompanying drawings, wherein

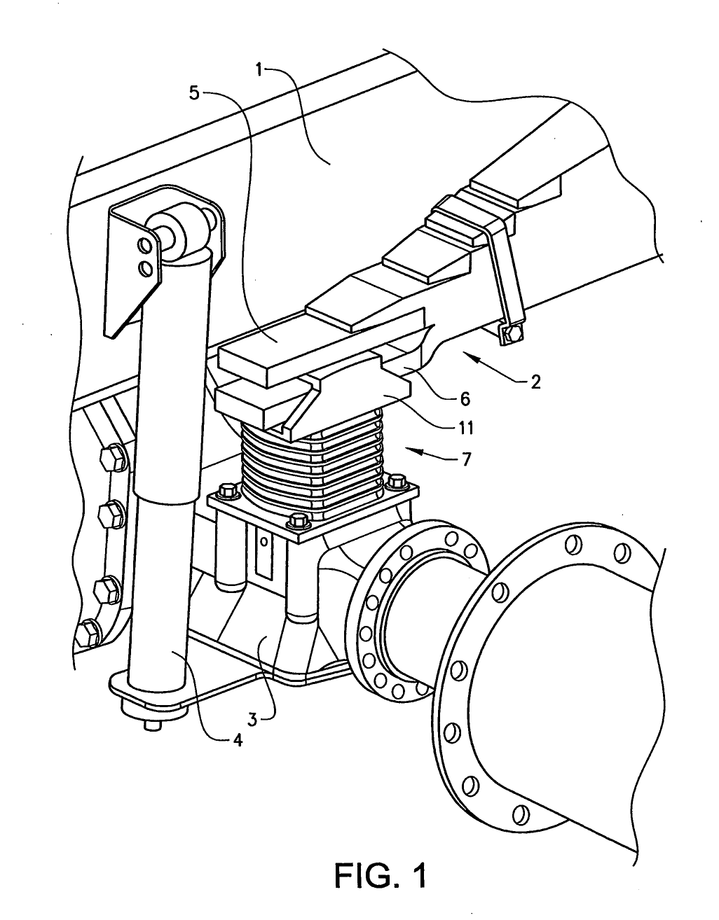

FIG. 1 is a perspective view of a portion of a previously known vehicle wheel leaf spring suspension incorporating rubber springs,

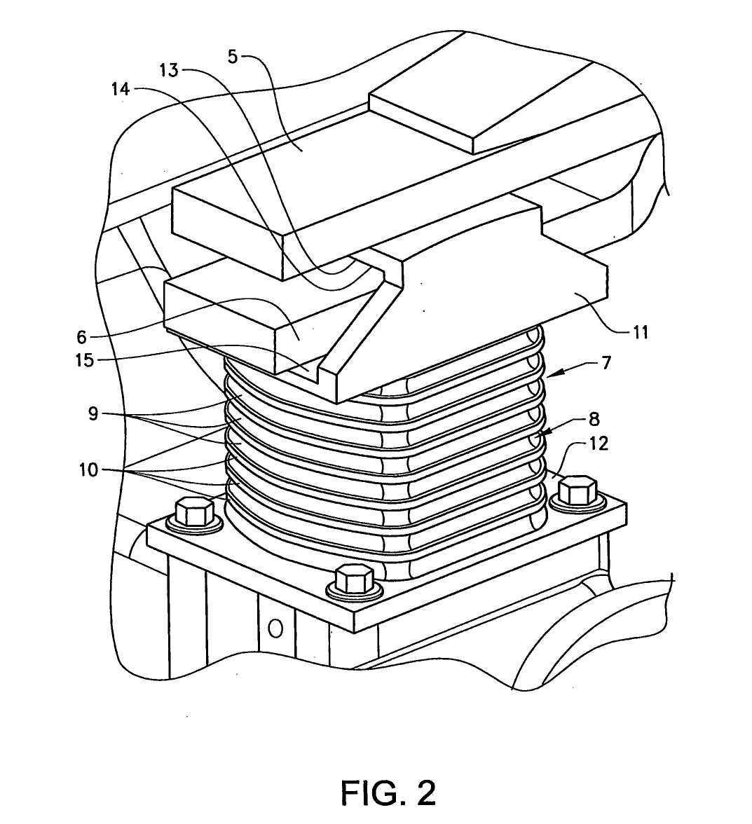

FIG. 2 is an enlargement of the rubber spring and spring leaves shown in FIG. 1,

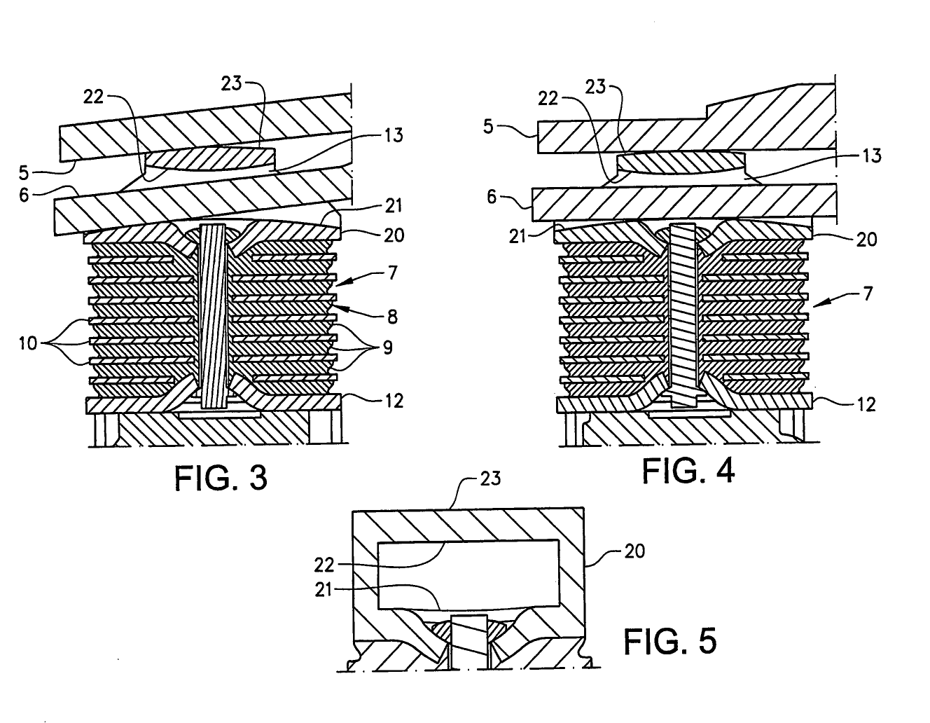

FIG. 3 is a longitudinal section of a rubber spring according to the present invention illustrating the relative position between the rubber spring and the spring leaves when the leaf spring is unloaded,

FIG. 4 is a longitudinal section of the rubber spring shown in FIG. 3 illustrating the relative position between the rubber spring and the spring leaves when the leaf spring is loaded, and

FIG. 5 shows a cross-section of the tunnel shaped mounting member of the rubber spring shown in FIGS. 3 and 4.

FIG. 1 shows a beam 1 of a truck frame supporting a leaf spring suspension, generally designated 2, which supports a wheel axle casing 3 on the frame beam 1. A shock absorber 4 is at one end connected to the frame beam 1 and at the other end to the wheel axle casing 3.

The leaf spring suspension 2 comprises a plurality of spring leaves, the two lower ones of which are designated 5 and 6. A rubber spring, generally designated 7, connects the lower spring leaf 6 with the wheel axle casing 3. The rubber spring 7 comprises a pillar 8 consisting of a plurality of rubber sections 9 vulcanized to intermediate metal plates 10. A tunnel shaped mounting member 11 is vulcanized to the uppermost rubber section 9 while a mounting plate 12 is vulcanized to the lowermost rubber section 9. The tunnel shaped mounting member 11 is in alternative embodiment screwed or riveted to the lowermost rubber section 9.

The lowermost spring leaf 6 extends through the tunnel 13 of the mounting member 11 with a slide fit while the mounting plate 12 is bolted to the wheel axle casing 3. Alignment of the interface of the wheel axle casing 3 and the mounting plate 12 with one another is a rather complicated procedure since the spring leaves, when the suspension 2 is unloaded, will be inclined in relation to a horizontal plane (see FIG. 3). A wheel axle 3 of the type described for a heavy truck can weigh up to one ton or even more and therefore manual alignment is not possible by tilting the wheel axle casing. Some form of power operated equipment has to be used, e.g. to load the end portion of the lower spring leaf 6 to a horizontal position before alignment.

The description above refers to a prior art leaf spring suspension. As is clearly shown in FIG. 2 the upper and lower surfaces 14 and 15 are plane and parallel with one another and since the leaf spring extends through the tunnel 13 with a slide fit no tilting of the rubber spring 7 relative to the spring leaf 6 is possible. The rubber spring 7 according to the present invention (FIGS. 3-5) differs from the one described above only in that it has a mounting member 20 which is slightly modified compared to the mounting member 11. As can be clearly seen in FIGS. 3 and 4 the mounting member 20 has opposite interior surfaces 21 and 22 which are convex in shape. This means that the rubber spring 7 can be tilted relative to the unloaded leaf springs 5 and 6 (FIG. 3) so as to be placed in a vertical position. Subsequently, after bolting the lower mounting plate 12 to the wheel axle casing 3 and loading the spring suspension, the rubber spring 7 and the leaf springs will have the position shown in FIG. 4.

In an embodiment of that type which is shown in FIGS. 3 and 4, wherein the second lowermost spring leaf 5 extends past the upper exterior surface 23 of the mounting member 11, also the surface 23 has to be convex in order to allow tilting.

Of course within the scope of the invention other shapes than strictly convex can be used for the surfaces 21 and 22 as long as the cross-section of the tunnel 13 increases from the mid-section towards the ends and the surface 23 slopes towards the ends to allow tilting of the rubber spring 7 relative to the spring leaves 5 and 6.

1. Rubber spring for a vehicle wheel axle suspension, said rubber spring (7) comprising a rubber pillar (8) attached at one end to a mounting plate (12) adapted to be fixed to a wheel axle casing (3) and at the opposite end to a tunnel shaped mounting member (11;20) for housing an end of a spring leaf (6) of a leaf spring suspension (2), said tunnel shaped mounting member having opposite interior surfaces (14,15;21,22) adapted to face opposite surfaces of a spring leaf (5), characterized in that said opposite interior surfaces (21,22) of the mounting member (20) are shaped so as to allow tilting of the pillar (8) relative to a first spring leaf (6) end housed in the tunnel (13).

2. Rubber spring according to claim 1, characterized in that said opposite interior surfaces (21,22) of the mounting member (20) are convex.

3. Rubber spring according to claim 1 or 2, characterized in that said mounting member (20) has an upper exterior surface (23) shaped so as to allow tilting of the pillar (8) relative to a second spring leaf (5) located above the first spring leaf (6).

4. Rubber spring according to claim 3, characterized in that said upper exterior surface (23) is convex.

5. Rubber spring according to one of claims 1-4, characterized in that the rubber pillar (8) is armed with a plurality of parallel metal plates (10).
